(19) United States
(12) Patent Application Publication
(10) Pub. No.: US 2002/0184830 A1
(43) Pub. Date: Dec. 12, 2002

(54) Building heat shield system

(76) Inventor: Roger D. Bias, Pasadena, CA (US)

Correspondence Address: Joseph N. Breaux, Suite A, 10630 N. Oak Hills Pkwy., Baton Rouge, LA, 70810, US

(21) Appl. No.: 10/143,630

(22) Filed: May 10, 2002

Related U.S. Application Data
(60) Provisional application No. 60/298,018, filed on Jun. 12, 2001.

(51) Int. Cl. E04B 1/34; B62D 63/04

(52) U.S. Cl. 52/3

(57) ABSTRACT

A building heat shield system that includes a number of panels or sheets of a laminate material that includes a reflective polyester plastic bonded to a transparent weather resistant plastic material. The laminate material is sufficiently reflective to reflect infrared, visible and ultraviolet radiation. In addition, the sheets may be mounted to a window shade type retraction mechanism so that the sheets may be extended in the summer and retracted during the winter.

### TECHNICAL FIELD

The present invention relates to building insulating systems and more particularly to a building heat shield system that includes a number of panels or sheets of a laminate material consisting of a thin sheet of reflective polyester plastic to which a thin layer of infrared transparent, weather resistant, Halar, Teflon, PFA or Polydimethylsilicone plastic has been permanently bonded; the reflective polyester plastic being reflective to infrared, visible and ultraviolet radiation; each of the laminated sheets being sufficiently flexible to roll onto a cylinder and may be mounted onto a window shade type of retraction mechanisms such that the laminated sheet may be extended in the summer when it is desirable to reflect the heat from a building and retracted during the winter when the heat added to the building would be an advantage.

### BACKGROUND OF INVENTION

It is often desirable to protect buildings from sunlight during periods of warm weather because the sunlight includes ultraviolet, visible and infrared radiation which causes the temperature of the interior of the building to rise. It would be desirable, therefore, to have a reflective sheeting system which could be easily deployed during hot weather to reflect the radiation from sunlight thereby preventing this such radiation from elevating temperatures within the building. Because the warmth from the sun's radiation may be desirable during cold weather, it would be further desirable to have such a reflective sheeting system which could be easily retracted or removed so that the sunlight could contact the surface of the building. The surface of the building would of course include the side walls and roof areas.

### SUMMARY OF INVENTION

It is thus an object of the invention to provide a building heat shield system that includes a number of panels or sheets of a laminate material consisting of a thin sheet of reflective polyester plastic to which a thin layer of infrared transparent, weather resistant, Halar, Teflon, PFA or Polydimethylsilicone plastic has been permanently bonded; the reflective polyester plastic being reflective to infrared, visible and ultraviolet radiation; each of the laminated sheets being sufficiently flexible to roll onto a cylinder and may be mounted onto a window shade type of retraction mechanisms such that the laminated sheet may be extended in the summer when it is desirable to reflect the heat from a building and retracted during the winter when the heat added to the building would be an advantage.

Accordingly, a building heat shield system is provided. The building heat shield system includes a number of panels or sheets of a laminate material consisting of a thin sheet of reflective polyester plastic to which a thin layer of infrared transparent, weather resistant, Halar, Teflon, PFA or Polydimethylsilicone plastic has been permanently bonded; the reflective polyester plastic being reflective to infrared, visible and ultraviolet radiation; each of the laminated sheets being sufficiently flexible to roll onto a cylinder and may be mounted onto a window shade type of retraction mechanisms such that the laminated sheet may be extended in the summer when it is desirable to reflect the heat from a building and retracted during the winter when the heat added to the building would be an advantage.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a side plan view of an exemplary embodiment of the building heat shield system showing one panel mounted to the side wall of a building.

FIG. 2 is a plan view showing a panel positioned on a section of the roof of a representative building.

### EXEMPLARY EMBODIMENTS

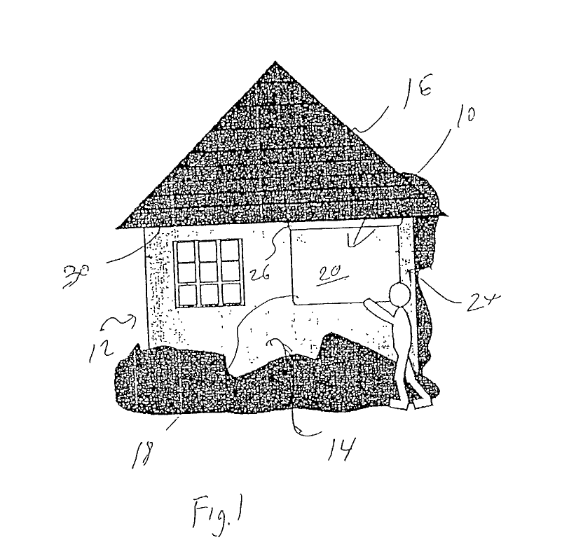

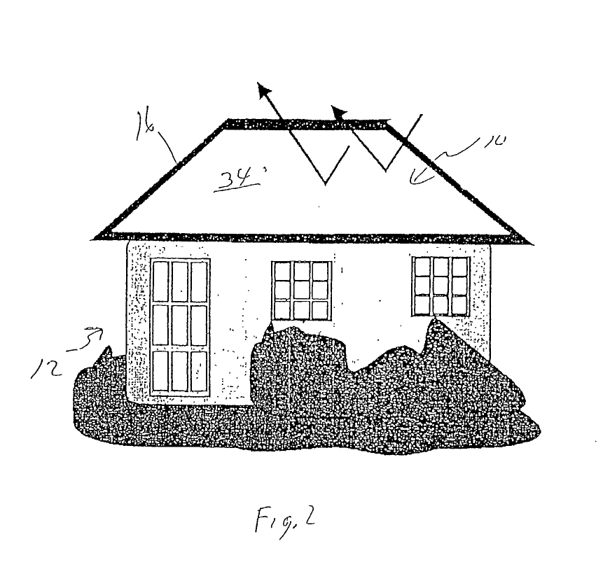

FIGS. 1 and 2 show various aspects of an exemplary embodiment of the building heat shield system of the present invention generally designated 10 in use on a representative house generally designated 12 having side surfaces 14 and a roof surface 16. The building heat shield system 10 includes a number of sheets of a laminate material including a reflective polyester plastic 18 covered by a protective plastic cover of Polydimethylsilicone plastic. Some of the sheets 24 are mounted on a window shade type retraction mechanism 26. These sheets 24 are mounted to the sides 14 or eaves 30 above the sides 14 such that the sheets may be extended to cover the sides 14 when desired. Also, in this embodiment sheets 34 that are cut to fit the shape of the roof surface 16 are provided. These sheets 34 are adhesively attached to the roofing material.

It can be seen from the preceding description that a building heat shield system has been provided.

It is noted that the embodiment of the building heat shield system described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. A building heat shield system comprising:
a number of panels or sheets of a laminate material formed from of a thin sheet of reflective polyester plastic to which a thin layer of infrared transparent, weather resistant, Halar, Teflon, PFA or Polydimethylsilicone plastic has been permanently bonded;
the reflective polyester plastic being reflective to infrared, visible and ultraviolet radiation;
each of the laminated sheets being sufficiently flexible to roll onto a cylinder and may be mounted onto a window shade or other retraction mechanisms such that the laminated sheet may be extended in the summer when it is desirable to reflect the heat from a building and retracted during the winter when the heat added to the building would be an advantage.
